(19) United States
(12) Patent Application Publication
(10) Pub. No.: US 2012/0139208 A1
(43) Pub. Date: Jun. 7, 2012

(54) Auxiliary Motorcycle Parking Stand

(76) Inventor: Chen-Kuo Tu, Chiayi County (TW)

(21) Appl. No.: 12/958,511

(22) Filed: Dec. 2, 2010

(51) Int. Cl. B62H 3/00

(52) U.S. Cl. 280/293

(57) ABSTRACT

An auxiliary motorcycle parking stand comprises a hollow casing having a positioning groove; a hollow clutch seat arranged inside the casing and having a through-hole; a base seat connected with the clutch seat and having a pedal; and an about L shape rod having a bolt and horizontally-arranged springs. A spring connects the clutch seat with the casing. The bolt penetrates the through-hole. The lower branch of the rod connects with a button. The parking stand is assembled to an object from the casing. When parking the object, the user pushes down the pedal to slide down the clutch seat and snap-fit the bolt into the positioning groove to assist in parking. When the parking stand is not in use, the user presses the button to move the rod backward and separate the bolt from the positioning groove, whereby the spring restores the clutch seat back to an original position.

### BACKGROUND OF THE INVENTION

1. Field of the Invention

The present invention relates to an auxiliary motorcycle parking stand, particularly to an easy-to-operate and labor-saving auxiliary parking stand to assist in parking a motorcycle or a heavy object.

2. Description of the Related Art

Generally, a motorcycle or a heavy object is anchored with a parking stand. However, the parking stands of the likes of a motorcycle are usually inconvenient and laborious to operate. When parking a motorcycle, the user pivotally pushes down the parking stand to prop against the ground and then pulls the motorcycle backward. The abovementioned operation is very laborious and inconvenient, especially for women. Based on many years' experience in the related field, the Inventor had devoted himself to overcoming the conventional problem with persistent research and experiments in order to develop a convenient and labor-saving motorcycle parking stand.

### SUMMARY OF THE INVENTION

The primary objective of the present invention is to provide an auxiliary motorcycle parking stand to assist in parking a motorcycle, whereby the user can park the motorcycle less laboriously with simple operations.

The auxiliary motorcycle parking stand of the present invention comprises a hollow casing; a hollow clutch seat arranged inside the casing; a base seat connected with the clutch seat, and an about L shape rod. The casing has a positioning groove. The clutch seat has a through-hole. A spring connects the clutch seat with the casing. The base seat has a pedal. The rod has a bolt at an upper position thereof and horizontally-arranged springs on an upper portion and a lower portion thereof. The bolt penetrates the through-hole of the clutch seat. The lower branch of the rod protrudes from the base seat and connects with a button. Thereby is formed the auxiliary motorcycle parking stand of the present invention. The auxiliary motorcycle parking stand is assembled to a motorcycle or a heavy object from the casing. When parking the motorcycle or heavy object, the user pushes down the pedal to slide down the clutch seat and snap-fit the bolt into the positioning groove to assist in parking. When the auxiliary motorcycle parking stand is not in use, the user presses the button to move the rod backward and separate the bolt from the positioning groove, whereby the spring restores the clutch seat back to the original position.

Besides, the base seat has a fixing frame at one side thereof, and one end of the pedal is pivotally coupled to the fixing frame. When the auxiliary motorcycle parking stand is not in use, the pedal is folded up for collection.

### BRIEF DESCRIPTION OF THE DRAWINGS

FIG. 1 is a diagram schematically showing the structure of an auxiliary motorcycle parking stand according to one embodiment of the present invention;

FIG. 2 is a diagram schematically showing the assemblage of an auxiliary motorcycle parking stand according to one embodiment of the present invention;

FIG. 3 is a diagram schematically the operation of an auxiliary motorcycle parking stand according to one embodiment of the present invention; and

FIG. 4 is another diagram schematically the operation of an auxiliary motorcycle parking stand according to one embodiment of the present invention.

### DETAILED DESCRIPTION OF THE PRESENT INVENTION

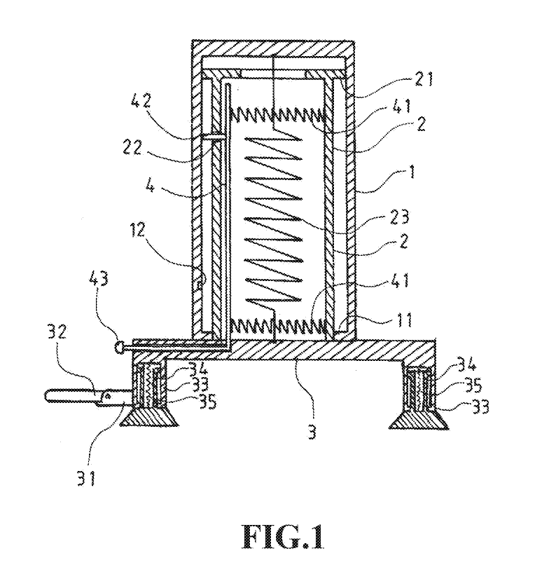

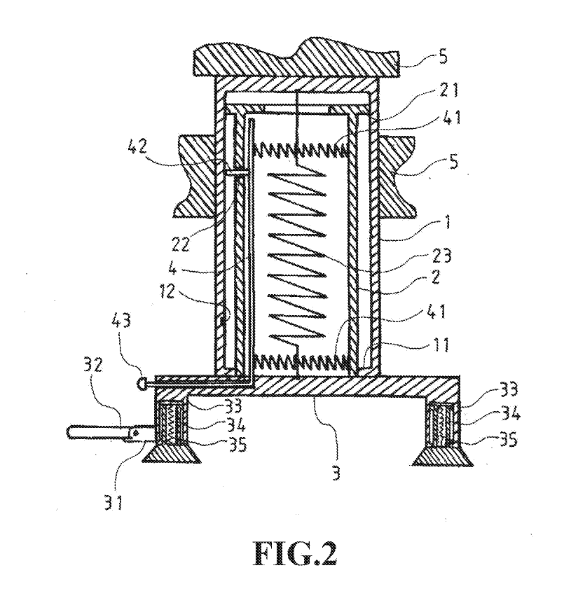

Refer to FIG. 1 and FIG. 2 respectively diagrams schematically showing the structure and assemblage of an auxiliary motorcycle parking stand according to one embodiment of the present invention. The auxiliary motorcycle parking stand of the present invention comprises a casing 1, a clutch seat 2 arranged inside the casing 1, a base seat 3 connected with the clutch seat 2, and a rod 4 penetrating the clutch seat 2 and the base seat 3. The casing 1 is hollow and has a block member 11 bent inward from the lower rim of the casing 1. The inner wall of the casing 1 has a positioning groove 12 at an appropriate position.

The clutch seat 2 is hollow and has a stop member 21 bent outward from the upper rim of the clutch seat 2. The vertical wall of the clutch seat 2 has a through-hole 22 at an appropriate position hereof. A spring 33 connects with the casing 1 and the clutch seat 2.

The base seat 3 has a fixing frame 31 at one side thereof. One end of a pedal 32 is pivotally coupled to the fixing frame 31. When the auxiliary motorcycle parking stand is not in use, the pedal 32 is folded up for collection. Each side of the base seat 3 have a casing 33, a clutch seat 34 and a spring 35 respectively similar to the abovementioned casing 1, clutch seat 2 and spring 23. Thereby, the base seat 3 can stretch or contract to adapt to an uneven surface of the ground.

The rod 4 has an about L shape and has horizontally-arranged springs 41 respectively at the upper and lower portions thereof. The rod 4 has a bolt 42 at an appropriate position of the upper portion thereof. The bolt 42 is inserted through the through-hole 22 of the clutch seat 2. The lower branch of the rod 4 protrudes from the base seat 3 and connects with a button 43.

When parked, the motorcycle is four-point supported by the parking stands of the front wheel and the rear wheel. Thereby, the motorcycle can be parked more handsomely and space-efficiently.

Via the abovementioned technical scheme is formed an auxiliary motorcycle parking stand. The auxiliary motorcycle parking stand is assembled to a parked object 5 from the casing 1. In a normal state, the clutch seat 2 is collected inside the casing 1 by the contracting force of the spring 23. When the motorcycle is being parked, the user pushes down the pedal 32 to slide down the clutch seat 2 and snap-fit the bolt 42 into the positioning groove 12 of the casing 1. Thereby, the present invention can assist in parking a motorcycle or a heavy object. When parked, the motorcycle is four-point supported by the parking stands of the front wheel and the rear wheel. Further, the casing 33, clutch seat 34 and spring 35 enable the base seat 3 to contract or stretch and adapt to an uneven surface of the ground. Thereby, the motorcycle can be parked more handsomely and space-efficiently. When the auxiliary motorcycle parking stand is not in use, the user presses the button 43 to move the rod 4 backward and separate the bolt 42 from the positioning groove 12. Then, the contracting force of the spring 23 restores the clutch seat 2 back to the original position.

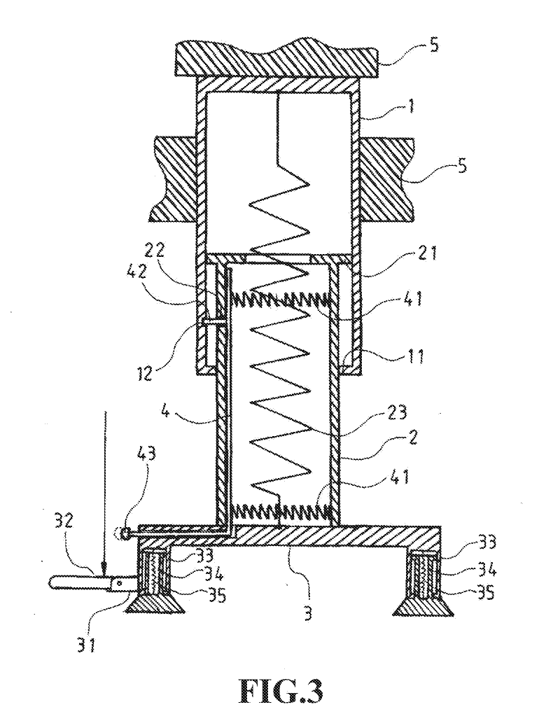

Refer to FIG. 3 a diagram schematically the operation of an auxiliary motorcycle parking stand according to one embodiment of the present invention. The auxiliary motorcycle parking stand is assembled to a parked object 5 from the casing 1. When the motorcycle is being parked, the user pushes down the pedal 32 to slide down the clutch seat 2. Once the clutch seat 2 slides to a given point, the elastic force of the spring 41 pushes the bolt 42 of the rod 4 to snap-fit into the positioning groove 12 of the casing 1. Thereby, the base seat 3 contacts the ground to assist in parking the motorcycle. As the casing 1 and the clutch seat 2 respectively have the block member 11 and the stop member 21, the clutch seat 2 would not drop out of the casing 1.

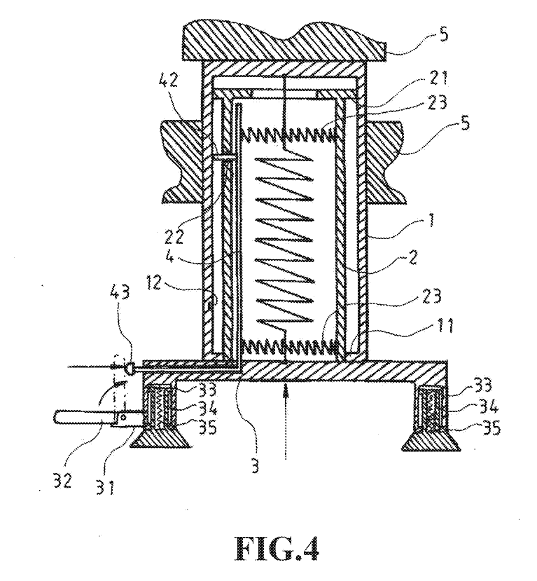

Refer to FIG. 4 another diagram schematically the operation of an auxiliary motorcycle parking stand according to one embodiment of the present invention. When the auxiliary motorcycle parking stand is not in use, the user presses the button 43 inward to move the rod 4 backward and separate the bolt 42 from the positioning groove 12. Thus, the contracting force of the spring 23 drives the free clutch seat 2 to slide back to the original position. Then, the pedal 32 is folded up for collection.

In conclusion, the present invention proposes an auxiliary motorcycle parking stand, which can assist the user in parking a motorcycle, whereby the user can park the motorcycle more easily via simple operations.

The embodiments described above are only to exemplify the present invention but not to limit the scope of the present invention. Any equivalent modification or variation according to the spirit of the present invention is to be also included within the scope of the present invention.

What is claimed is:

1. An auxiliary motorcycle parking stand comprising
a casing being hollow and having a positioning groove at an inner wall thereof;
a clutch seat being hollow, arranged inside said casing, having a through-hole at a vertical wall thereof, and connected to said casing via a spring;
a base seat having a pedal at one side thereof, and
a rod having an about L shape, having a bolt arranged at an appropriate position of an upper portion thereof and penetrating said through-hole of said clutch seat, and having horizontally-arranged springs respectively on an upper portion and a lower portion thereof,
wherein a lower branch of said rod protrudes from said base seat and connects with a button, and
wherein said casing is assembled to a parked object, and
wherein said parked object is a motorcycle or a heavy object, and
wherein when a user intends to park said motorcycle or said heavy object, said user pushes down said pedal to slide down said clutch seat and snap-fit said bolt into said positioning groove of said casing to assist in parking said motorcycle or said heavy object, and
wherein when said auxiliary motorcycle parking stand is not in use, said user presses said button to move said rod backward and separate said bolt from said positioning groove, whereby contracting force of said spring restores said clutch seat back to an original position.

2. The auxiliary motorcycle parking stand according to claim 1, wherein said casing has a block member bent inward from a lower rim thereof, and said clutch has a stop member bent outward from an upper rim thereof, and wherein said block member and said stop member are used to prevent said clutch seat from sliding out of said casing.

3. The auxiliary motorcycle parking stand according to claim 1, wherein said base seat has a fixing frame at one side thereof, and one end of said pedal is pivotally coupled to said fixing frame, and wherein when said auxiliary motorcycle parking stand is not in use, said pedal is folded up for collection.
